(19) United States
(12) Patent Application Publication
(10) Pub. No.: US 2025/0087782 A1
(43) Pub. Date: Mar. 13, 2025

(54) BATTERY ARRANGEMENTS WITH SUPERCOOLED PHASE CHANGE MATERIALS

(71) Applicant: FORD GLOBAL TECHNOLOGIES, LLC, DEARBORN, MI (US)

(72) Inventors: Minghong Liu, Northville, MI (US); Hao Wu, Northville, MI (US)

(21) Appl. No.: 18/463,524

(22) Filed: Sep. 8, 2023

(51) Int. Cl. H01M 10/653; H01M 10/44; H01M 10/615; H01M 10/625

(52) U.S. Cl. CPC H01M 10/653; H01M 10/44; H01M 10/615; H01M 10/625; B60R 16/033; H01M 2220/20

(57) ABSTRACT

A PCM with supercooling function may be used to release heat to warm a battery prior to fast charging by triggering a solidifying phase change in the PCM with supercooling function. A battery temperature management system may include a PCM with supercooling function in a temperature-modulating cell to supply heat to a battery prior to fast charging and to absorb heat during fast charging. A vehicle may include a battery and a PCM with supercooling function in a temperature-modulating cell to supply heat to the battery prior to fast charging and to absorb heat during fast charging.

### TECHNICAL FIELD

This disclosure relates to battery management systems.

### BACKGROUND

Within the context of certain batteries, lower operating temperatures may influence rates of lithium plating and charge acceptance. As such, warming a battery before fast charging may increase charge acceptance.

### SUMMARY

A method includes, responsive to a request to charge a battery, triggering a first phase change in a supercooled phase change material (“PCM”) of a composition adjacent to the battery that solidifies the PCM to release a latent stored heat to warm the battery, and during charging, the PCM absorbing heat while undergoing a second phase change that liquifies the PCM to cool the battery.

A battery temperature management apparatus includes a temperature-modulating cell, containing a composition including a phase change material (“PCM”) configured to be supercooled, adjacent to a battery, an ultrasonic transducer, and a controller programmed to activate the ultrasonic transducer upon receiving a request to charge the battery, the ultrasonic transducer's activation causing a first phase change in the PCM, solidifying the PCM to release a latent stored heat.

A vehicle includes a battery, a temperature-modulating cell, containing a composition including a phase change material (“PCM”) configured to be supercooled, adjacent to the battery, a submerged disc, and a controller programmed to, upon receiving a request to charge the battery, send an electric signal to perturb the disc to trigger a first phase change in the PCM, solidifying the PCM to release a latent stored heat.

### BRIEF DESCRIPTION OF THE DRAWINGS

FIG. 1 shows a method to use a PCM with supercooling function to warm and, at another time, cool a battery cell.

FIG. 2 shows a battery temperature management apparatus.

FIG. 3 shows an example operation of the battery temperature management apparatus of FIG. 2.

FIG. 4 shows a vehicle.

FIG. 5 shows an example operation of the vehicle of FIG. 4.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Fast charging may cause a battery to degrade faster compared to other charging modes. Such degradation may be more likely at a “low temperature” below 30° C. The low temperature may cause a reduced ion transfer rate which may limit the ability of ions to reach the bottom of the electrode. This reduced ion transfer rate may result in a slower charge. Charging at the low temperature may also cause lithium plating on the anode surface. Some lithium plating is irreversible, so this process may reduce the battery's lithium inventory, reducing the cycle life of the battery.

A “target temperature” such as a temperature between about 30° C. to about 50° C. may quicken ion transfer and mitigate the lithium plating when fast charging. By increasing the ion conductivity and diffusion in the electrode, a target temperature may lower the polarization in the anode material surface and may result in a faster charge and longer cycle life of the battery.

A “high temperature” such as a temperature above 60° C. may cause a side reaction to reduce battery life. Thus, a high temperature should be avoided.

Known battery temperature management systems may include using a phase change material (“PCM”) or a mixture of PCMs to passively absorb heat above a certain temperature. Example PCMs may include organic materials, inorganic materials, and salt eutectics. For example, a paraffin absorbs heat as the paraffin liquifies to assume a more energetic phase. Because heat dissipation is a goal of these established methods, many methods teach away from a PCM with supercooling function (a super cooled PCM) that would retain the heat until seeded to encourage crystallization.

A PCM with supercooling function may be included in a battery temperature management system to increase charging acceptance and lengthen cycle life by warming a battery cell prior to fast charging. Including a PCM with supercooling function in a battery temperature management system allows for cooling a battery, and also allows for storing energy and for releasing that energy at a predetermined time and in a predetermined manner to warm the battery for fast charging.

The PCM with supercooling function can be included within a composition contained by a temperature-modulating cell. A volume of the composition can be less than a total volume of the temperature-modulating cell such that the composition can expand to fill a space defined by the temperature-modulating cell when changing phase.

Certain prior battery temperature management systems designed to warm a battery for fast charging do so by passing a current through a resistively heatable material, either internal or external to the battery. Passing the current requires a power source: either the battery itself or an additional source external to the battery. Prior battery temperature management systems may affect a performance of the battery, such as if the battery itself provides a power to a resistively heatable material, or may include additional components which may occupy space or increase weight.

In a system including a PCM with supercooling function, the energy used to pre-heat the battery for fast charging is energy stored in the PCM from the last time the PCM was warmed above its melting point, including possibly the last time the battery was fast charged. Further, the battery temperature management system including a PCM with supercooling function may use an external power to activate a trigger.

A PCM may have a different melting point or a different latent heat compared to another PCM. By including a mixture of two or more PCMs determined via testing, simulation, etc., a composition can have a melting point, for example between 35° C. and 60° C., and a latent heat as required by the application of the battery temperature management system. For example, a composition with a greater latent heat may warm a battery cell to a higher temperature than would a composition with a lesser latent heat in an equivalent system and environment.

A composition including a PCM with supercooling function may have a thermal conductivity less than necessary to warm an adjacent battery cell to a target temperature. For example, a composition including a PCM and an additive with a thermal conductivity greater than the PCM may transfer heat to warm an adjacent battery cell to a higher temperature than would a composition with the PCM alone in an equivalent system and environment. Example additives may include graphite or a metal foam.

A relationship between a mass of a composition including a PCM with supercooling function and a mass of a battery cell may affect whether the composition will warm the battery cell to a target temperature. The total heat contained in the mass of the composition, measured in J, may be determined by a latent heat of the composition, measured in J/kg, multiplied by the mass of the composition, measured in kg. Similarly, a resulting temperature change of the battery cell, measured in° C., may be determined by dividing a specific heat of the battery, measured in J/(kg*° C.), and the mass of the battery, measured in kg, into the heat delivered to the battery cell from the composition, measured in J.

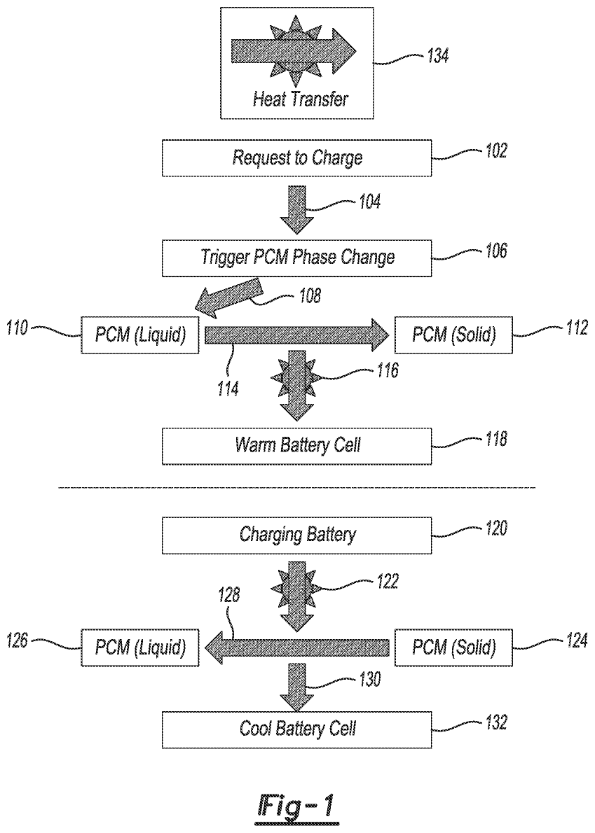

FIG. 1 shows a method to use a PCM with supercooling function to warm a battery cell and, at another time, cool the battery cell. A key 134 shows that an arrow-plus-sunburst denotes heat transfer. The figure shows a request to charge 102 conveyed 104 to trigger a phase change in the PCM with supercooling function 106. This triggering 106 applied 108 to a supercooled liquid PCM 110 causes a solidifying phase change 114. As the liquid PCM 110 undergoes a solidifying phase change 114 to become a solid 112, heat is released 116 and warms an adjacent battery cell 118. While a battery is charging 120, heat is generated 122 and causes a liquifying phase change 128 in a solid PCM 124. As the solid PCM 124 undergoes a liquifying phase change 128 to become a liquid 126, the phase change 128 draws heat away from the battery 122, resulting 130 in a cooling of a battery cell 132.

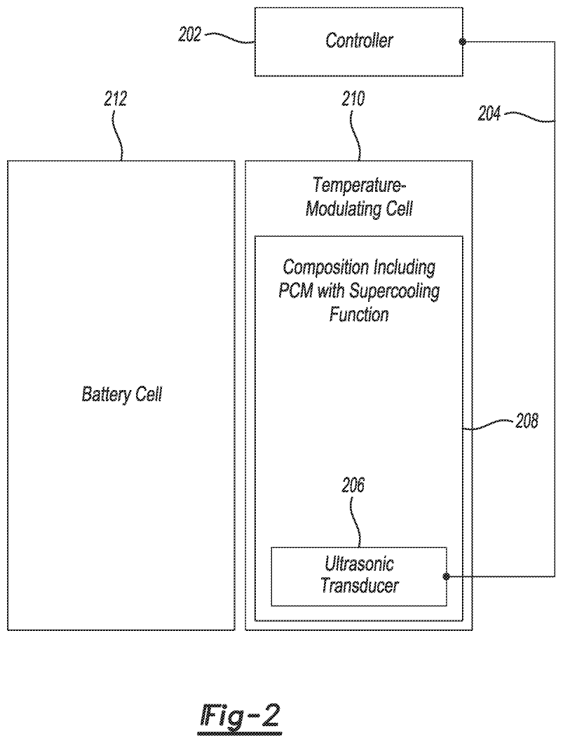

FIG. 2 shows a battery temperature management apparatus. The battery temperature management apparatus includes a battery cell 212 adjacent to a temperature-modulating cell 210. The temperature-modulating cell 210 includes a composition including a PCM with supercooling function 208. An ultrasonic transducer 206 is included in the composition 208, and the ultrasonic transducer 206 is connected 204 to a controller 202. In FIG. 2, the ultrasonic transducer 206 is shown immersed in the composition 208, and the ultrasonic transducer 206 is shown directly connected 204 to the controller 202. Some embodiments may include the ultrasonic transducer 206 not immersed as depicted, but instead adjacent to the composition 208 or external to the temperature-modulating cell 210. Some embodiments may replace the ultrasonic transducer 206 with a different trigger to seed the PCM with supercooling function, such as a submerged disc that is perturbed by an electric signal. Some embodiments may connect the controller 202 and the ultrasonic transducer 206 indirectly through an intermediary component or wirelessly.

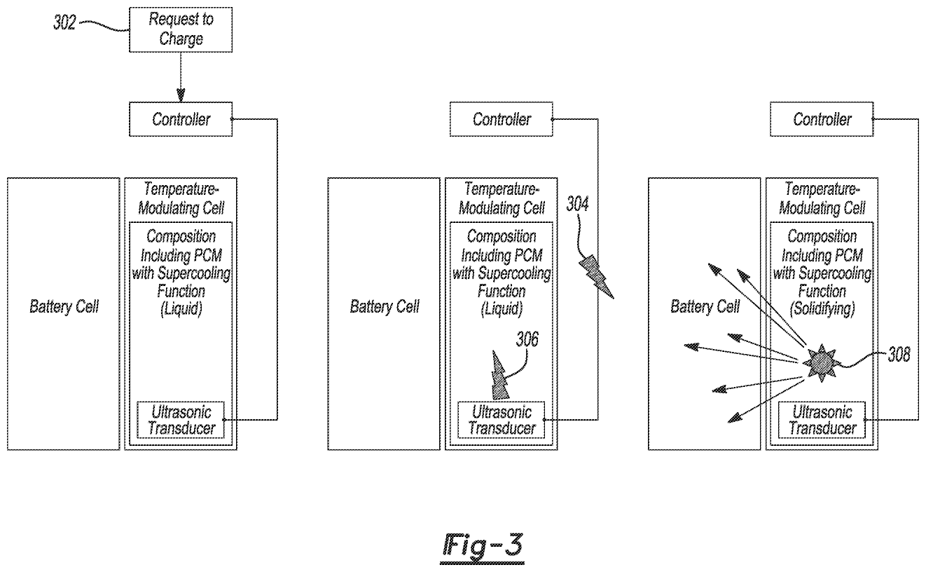

FIG. 3 shows an example operation of the battery temperature management apparatus of FIG. 2. The controller receives a request to charge 302. The controller activates 304 the ultrasonic transducer and the ultrasonic transducer triggers 306 the composition including a PCM with supercooling function to undergo a solidifying phase change. The phase change generates a heat 308 that conducts to an adjacent battery cell.

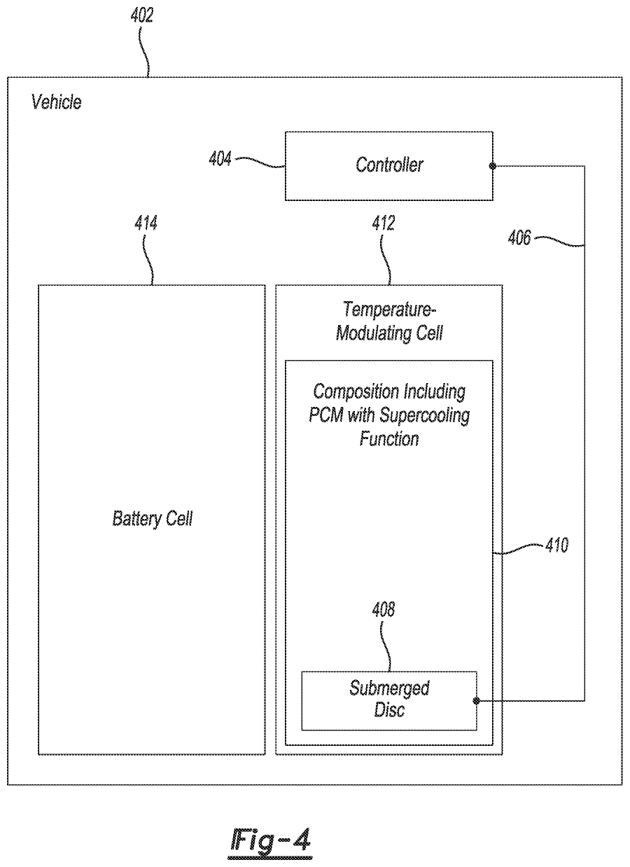

FIG. 4 shows a vehicle 402. The vehicle 402 includes a controller 404, and the vehicle 402 includes a battery cell 414 adjacent to a temperature-modulating cell 412. The temperature-modulating cell 412 includes a composition including a PCM with supercooling function 410. A submerged disc 408 is included in the composition 410, and the submerged disc 408 is connected 406 to the controller 404. In FIG. 4, the submerged disc 408 is shown directly connected 406 to the controller 404. Some embodiments may connect the controller 402 and the submerged disc 408 indirectly through an intermediary component or wirelessly. Some embodiments may replace the submerged disc 408 with a different trigger, such as an ultrasonic transducer, to seed the PCM with supercooling function. Some embodiments may connect the controller 404 and the submerged disc 408 indirectly through an intermediary component or wirelessly. Some embodiments may include the submerged disc 408 including a metallic substance.

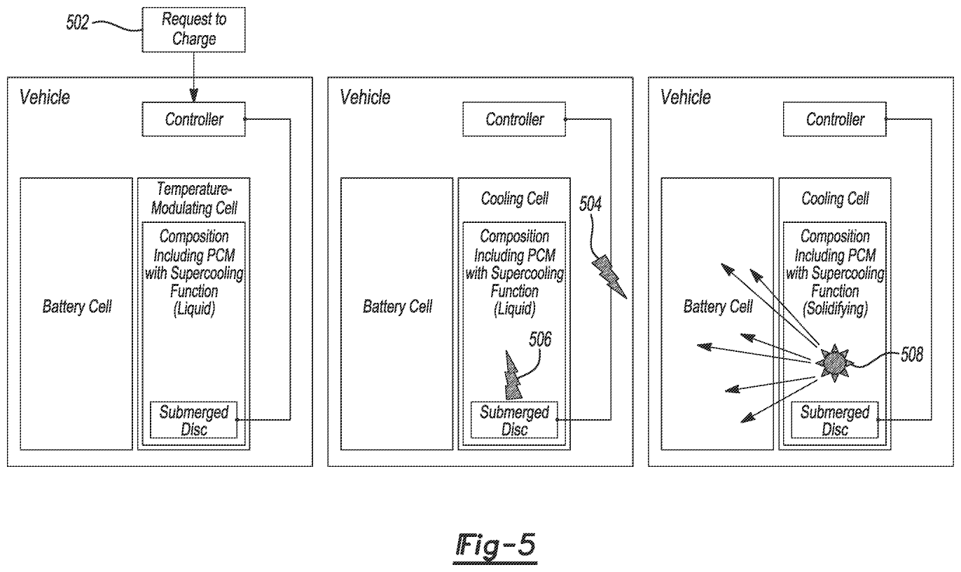

FIG. 5 shows an example operation of the vehicle of FIG. 4. A request to charge 502 is transmitted to the controller. The controller perturbs 504 the submerged disc and the perturbation triggers 506 the composition including a PCM with supercooling function to undergo a solidifying phase change. The phase change generates a heat 508 that conducts to an adjacent battery cell. A predetermined mass of the composition is such that the battery cell is warmed to between 30°° C. and 50° C. The amount of mass to accomplish this warning can be determined via testing, simulation, etc. In FIG. 5, the request to charge 502 is depicted as originating outside the vehicle. Some embodiments may include a request to charge 502 originating from inside the vehicle.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method comprising:
responsive to a request to charge a battery, triggering a first phase change in a supercooled phase change material (“PCM”) of a composition adjacent to the battery that solidifies the PCM to release a latent stored heat to warm the battery; and
during charging, the PCM absorbing heat while undergoing a second phase change that liquifies the PCM to cool the battery.

2. The method of claim 1 wherein the triggering includes activating an ultrasonic transducer to seed solidification of the composition.

3. The method of claim 1 wherein the triggering includes perturbing a submerged disc with an electric signal to seed solidification of the composition.

4. The method of claim 1 wherein the composition includes a thermally conductive additive such that thermal conductivity of the composition including the additive is greater than thermal conductivity of the PCM.

5. The method of claim 1 wherein a predefined mass of the composition is used to warm the battery to between 30° C. and 50° C.

6. The method of claim 1 wherein the composition includes a predefined mixture of PCMs such that a melting point of the composition is between 35° C. and 60° C.

7. A battery temperature management apparatus comprising:
a temperature-modulating cell, containing a composition including a phase change material (“PCM”) configured to be supercooled, adjacent to a battery;
an ultrasonic transducer; and
a controller programmed to activate the ultrasonic transducer upon receiving a request to charge the battery resulting in a first phase change in the PCM that solidifies the PCM and releases a latent stored heat.

8. The battery temperature management apparatus of claim 7 wherein the temperature-modulating cell contains a volume of the composition less than a total volume of the temperature-modulating cell such that the composition can expand to fill a space defined by the temperature-modulating cell when changing phase.

9. The battery temperature management apparatus of claim 7 wherein the temperature-modulating cell includes a predetermined mass of the composition to warm the battery to between 30° C. and 50° C.

10. The battery temperature management apparatus of claim 7 wherein the composition includes a mixture of PCMs such that a melting point of the composition is between 35° C. and 60° C.

11. The battery temperature management apparatus of claim 7 wherein the composition further includes a thermally conductive additive such that thermal conductivity of the composition including the additive is greater than thermal conductivity of the PCM.

12. The battery temperature management apparatus of claim 11 wherein the thermally conductive additive includes a metal foam.

13. The battery temperature management apparatus of claim 11 wherein the thermally conductive additive includes graphite.

14. A vehicle comprising:
a battery;
a temperature-modulating cell, containing a composition including a phase change material (“PCM”) configured to be supercooled, adjacent to the battery;
a submerged disc; and
a controller programmed to, upon receiving a request to charge the battery, send an electric signal to perturb the disc to trigger a first phase change in the PCM, solidifying the PCM to release a latent stored heat.

15. The vehicle of claim 14 wherein the temperature-modulating cell contains a volume of the composition less than a total volume of the temperature-modulating cell such that the composition can expand to fill a space defined by the temperature-modulating cell when changing phase.

16. The vehicle of claim 14 wherein the temperature-modulating cell includes a predetermined mass of the composition to warm the battery to between 30° C. and 50° C.

17. The vehicle of claim 14 wherein the composition includes a mixture of PCMs such that the melting point of the composition is between 35° C. and 60° C.

18. The vehicle of claim 14 wherein the composition further includes a thermally conductive additive such that thermal conductivity of the composition including the additive is greater than thermal conductivity of the PCM.

19. The vehicle of claim 14 wherein the thermally conductive additive is a metal foam.

20. The vehicle of claim 14 wherein the thermally conductive additive is graphite.
